(19) United States
(12) Patent Application Publication
(10) Pub. No.: US 2007/0161398 A1
(43) Pub. Date: Jul. 12, 2007

(54) Electronic mobile device having a turnable game handle

(75) Inventors: Po-Yen Chiu, Taipei (TW); Hsiang Chen, Taipei (TW)

Correspondence Address: BACON & THOMAS, PLLC, 625 SLATERS LANE, FOURTH FLOOR, ALEXANDRIA, VA, 22314, US

(73) Assignee: INVENTEC CORPORATION, Taipei (TW)

(21) Appl. No.: 11/330,241

(22) Filed: Jan. 12, 2006

(51) Int. Cl. H04M 1/00

(52) U.S. Cl. 455/550.1

(57) ABSTRACT

The present invention discloses an electronic mobile device having a turnable game handle that includes a main body, a display screen disposed on a lateral side of the main body, a first press key portion separately disposed on both ends of the display screen of the main body, and a first handle and a second handle separately and pivotally coupled to both ends of another lateral side of the main body, and the two handles can be turned and stored into the another lateral side of the main body or can be turned outward to a specific angle from the main body for providing operators to hold the handles by both hands.

### FIELD OF THE INVENTION

The present invention relates to an electronic mobile device, and more particularly to an electronic mobile device having two handles separately and pivotally coupled to both ends of one side of a main body thereof, and the two handles can be turned and stored into the side of the main body or can be turned outward to a specific angle from the side of the main body for providing operators to hold the handles by both hands.

### BACKGROUND OF THE INVENTION

As the information and electronic industries bloom, high-tech products derived from computers and mobile communications are developed rapidly, and these products are closely related to our daily life that shorten the distance between people as well as the time and space. Electronic products (such as mobile phones, persona digital assistant (PDA), and other handheld computers) become popular and extensively used. With manufacturers' promotions, the competition in the market becomes severer and major communication companies constantly introduce innovative products and services to attract users, and thus users have a higher demand on the use of electronic communication products. The convenience and effective service of the electron communication products become an important index for evaluating the manufacturing technology of high-tech products in a country.

Particularly, mobile phones are used more extensively in our daily life, and the function of playing a JAVA game provided by mobile phones is very common. Most of the JAVA games provided for users to play are motion type and intellectual type, and thus such JAVA games not only attract users to operate the mobile phone with full attention, but the mobile phone also provides users a place for showing off their skill. Referring to FIG. 1 for a prior art mobile phone, most of the operations set the numeric keys 510 including “2”, “4”, “6”, and “8” on a mobile phone as the direction keys for playing a JAVA game, and the decision keys (such as the shooting key or jumping key) in the JAVA game are set to other easily identified keys 520 (such as the numeric key “5”).

Since the prior art mobile phone is light, thin, short, and compact, and the space available for arranging these keys is very limited. Foreigners or people having a larger palm usually cannot hold the mobile phone by both hands, or users having wider fingers usually press two keys at a time or a wrong key while playing the game, and thus causing inconvenience and distraction to the operator.

Therefore, finding a way of designing an electronic mobile device having a turnable game handle that allows an operator to enjoy and concentrate on the games provided by the mobile phone is definitely an important issue for electronic communication product designers and manufacturers to overcome.

### SUMMARY OF THE INVENTION

In view of the shortcomings of the prior art mobile phone that is light, thin, short, and compact and has a very limited space for arranging the keys, and operators may have difficulties to hold the mobile phone stably, or may press the wrong keys during the game, the inventor of the present invention based on years of experience to conduct extensive researches and experiments, and finally invented an electronic mobile device having a turnable game handle in accordance with the present invention.

Therefore, it is a primary objective of the present invention to provide an electronic mobile device having a turnable game handle that comprises a main body, a display screen disposed on a lateral side of the main body, a first press key portion separately disposed on both ends of the display screen of the main body, and a first handle and a second handle separately and pivotally coupled to both ends of another side of the main body, and the two handles can be turned and stored into another lateral side of the main body or can be turned outward to a specific angle from the main body for providing operators to hold the handles by both hands.

Another objective of the present invention is to construct a raised member separately disposed on the two handles and at the side facing the main body, such that the raised member can latch the two handles separately into a groove of the main body when the two handles are turned outward from the main body, and after the raised member is constructed at one side of the main body, the raised member can be latched into another groove corresponding to the raised member and disposed on the main body, so that when the two handles are used for playing games or placed into one side of the main body, the two handles can be fixed to a position of the main body, and the two handles will not slide freely that may cause inconvenience to users.

The above and other objects, features and advantages of the present invention will become apparent from the following detailed description taken with the accompanying drawings.

### BRIEF DESCRIPTION OF THE DRAWINGS

FIG. 1 is a schematic view of a prior art mobile phone;

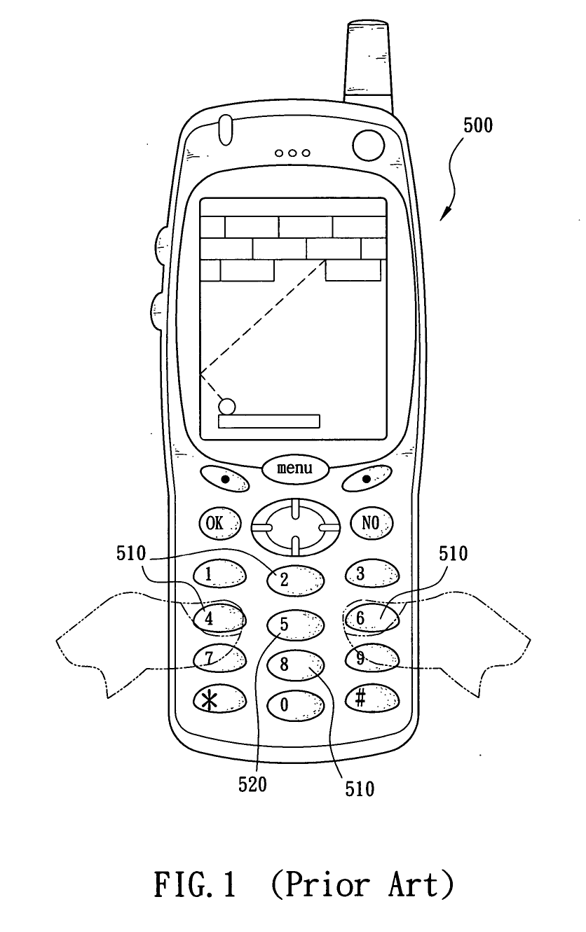

FIG. 2 is a schematic view of two handles being turned out according to a preferred embodiment of the present invention;

FIG. 3 is a schematic view of a preferred embodiment of the present invention; and

FIG. 4 is a schematic view of a single handle of a preferred embodiment of the present invention.

### DETAILED DESCRIPTION OF THE PREFERRED EMBODIMENTS

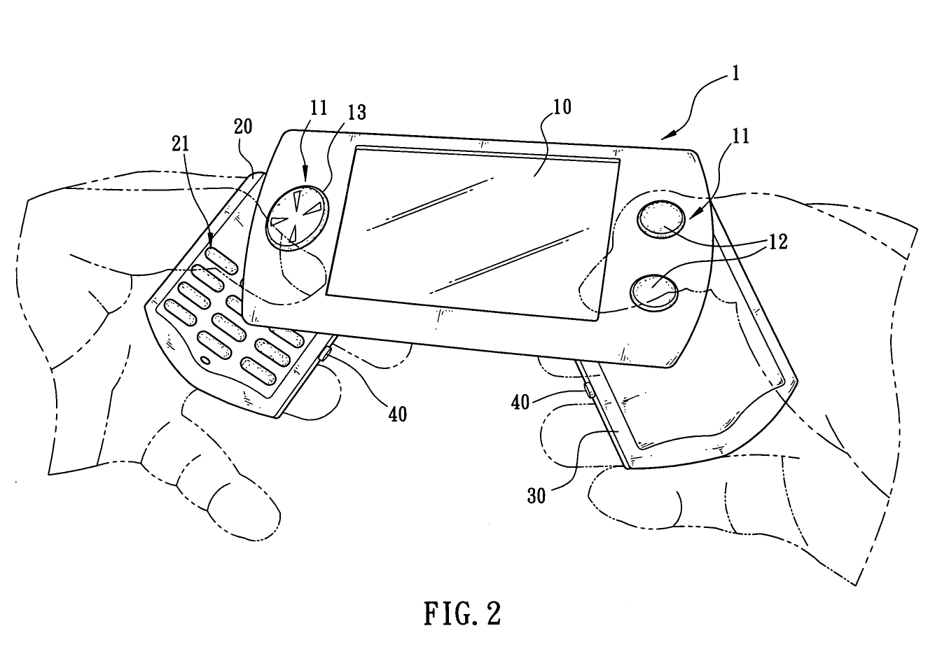

Referring to FIG. 2 for the electronic mobile device having a turnable game handle in accordance with the present invention, the electronic mobile device such as a mobile phone or a personal digital assistant (PDA) comprises a main body 1, a first handle 20, and a second handle 30. The main body 1 at its lateral side has a display screen 10 (such as a touch panel) and two first press key portions 11, and the two first press key portions 11 are disposed separately on the main body 1 and proximate to both ends of the display screen 10, and the first handle 20 and second handle 30 are separately and pivotally coupled to the main body 1 and at two corresponding ends of another side having the display screen 10. The first handle 20 and second handle 30 can be movably turned at a lateral side of the main body 1, and the first handle 20 includes a second press key portion 21 at a lateral side facing the main body 1, and the first handle 20 and second handle 30 can be turned and stored in a lateral side of the electronic mobile device, or the first handle 20 and second handle 30 can be turned outward to a specific angle for the game mode, so as to provide an area for an operator to hold by both hands.

Referring to FIG. 2 for the preferred embodiment of the present invention, the first press key portion 11 includes a cross-shape direction key 13 disposed at an end of the display screen 10, and the first press key portion 11 includes a plurality of control keys 12 disposed at another end of the display screen 10. If the first handle 20 and second handle 30 are turned outward to a specific angle, the cross-shape direction key 13 can be operated by the operator's left thumb, and the first handle 20 can be held by the rest four fingers of the operator's left hand, and the control keys 12 can be operated by the operator's right thumb, and the second handle 30 on the same end can be held by the rest four fingers of the operator's right hand. Further, the first and second handles 20, 30 separately have single-finger key 40 disposed on the same lateral side, and the two single-finger keys 40 can be operated by the operator's middle fingers to input instructions in a game mode.

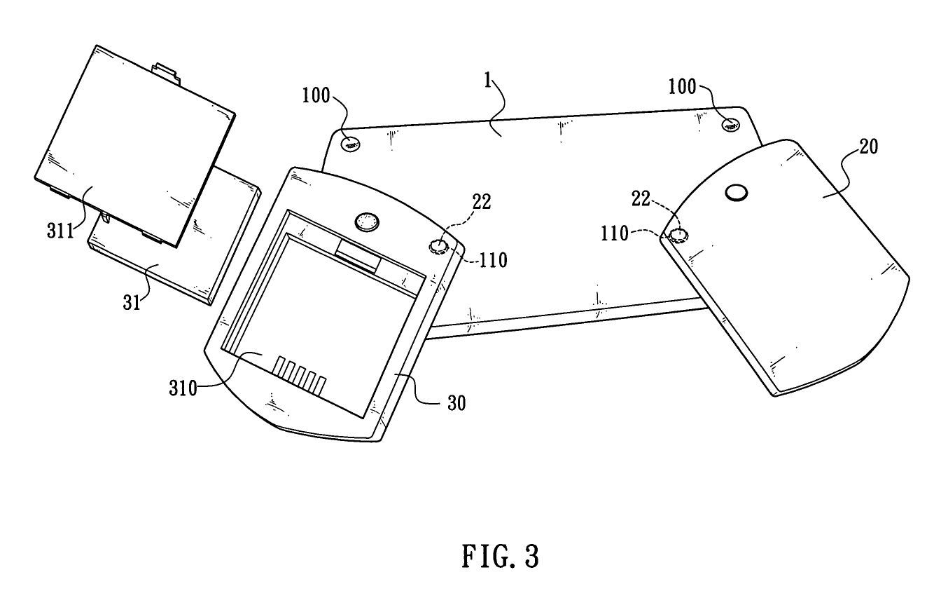

In the preferred embodiment as shown in FIG. 3, a free end of the first and second handles-20, 30 is substantially in a circular arc shape, and the first and second handles 20, 30 are stored in a lateral side of the main body 1 or the first and second handles 20, 30 are turned outward, such that the circular arc shaped free ends of the first and second handles 20, 30 will not interfere with each other and cannot be stored into a lateral side of the main body 1 successfully.

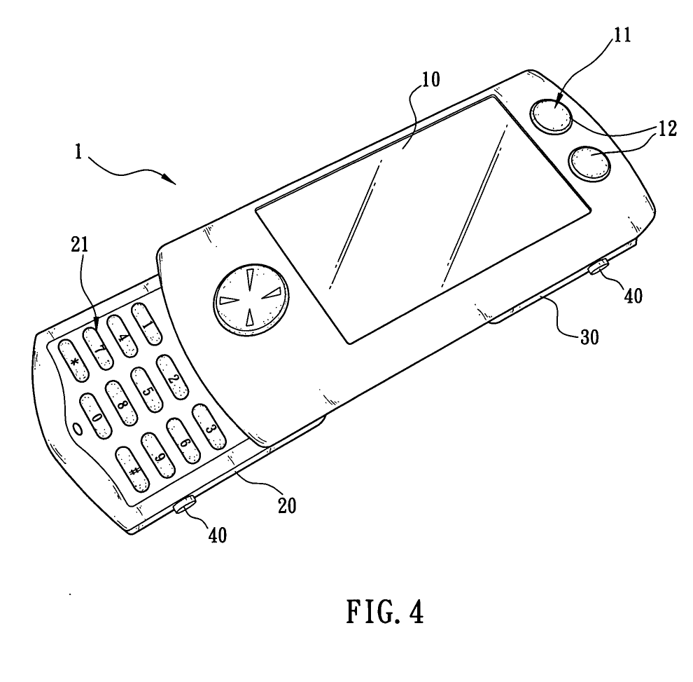

In the preferred embodiment as shown in FIGS. 3 and 4, the second press key portion 21 could be a keyboard (such as a numeric pad). When the first handle 20 is turned outward from the main body 1 and parallel to the main body 1, the keyboard can be used for dialing a call. The second handle 30 at its end includes a power supply slot 310 and a cover 311, and the power supply slot 310 can contain a power supply portion 31 (such as a battery), and the cover 311 can cover the power supply slot 310. After the power supply portion 31 opens the cover 311 from an end of the power supply slot 310, the power supply portion 31 can be removed or replaced.

Referring to FIGS. 3 and 4, the first handle 20 and second handle 30 of the invention separately include a raised member 22 at one side facing the main body 1, such that after the first handle 20 and second handle 30 are turned outward from the main body 1 to a specific angle, the raised member 22 can be latched into a groove 100 of the main body 1. After the raised member 22 is placed onto another lateral side of the main body 1, the raised member 22 can be latched into another groove 110 disposed on the main body 1 and corresponding to the raised member 22, so that when the first handle 20 and second handle 30 are in a game mode or placed back to a lateral side of the main body 1, the first handle 20 and second handle 30 can be fixed to the main body 1, and the first handle 20 and second handle 30 will not slide freely that may cause inconvenience to users.

In summation of the description above, the two handles 20, 30 of the invention provide more stable gripping space for the operator. Compared with the game operating method of the prior art electronic mobile devices, the game operating method by the two handles 20, 30 according to the present invention is improved, and the present invention complies with the patent application requirements.

While the invention herein disclosed has been described by means of specific embodiments, numerous modifications and variations could be made thereto by those skilled in the art without departing from the scope and spirit of the invention set forth in the claims.

What is claimed is:

1. An electronic mobile device having a turnable game handle, comprising:
a main body, having a display screen disposed on a lateral side of said main body, and a first press key portion disposed separately on both ends of said display screen;
a first handle, pivotally coupled to an end of said main body and movably turned at another lateral side of said main body, and said first handle being turned outward to a specific angle to provide a gripping area, and said first handle including a second press key portion disposed on a side facing said main body; and
a second handle, pivotally coupled to said main body and at an end opposite to said first handle and movably turned at the another lateral side of said electronic mobile device, and said second handle being turned outward to a specific angle for providing a gripping area.

2. The electronic mobile device of claim 1, wherein said two handles separately include a raised member on a side facing said main body, such that when said two handles are turned outward to a specific angle, said two handles are fixed separately and precisely into a groove of said main body corresponding to said raised member.

3. The electronic mobile device of claim 2, wherein said first and second handles separately have a free end substantially in a circular arc shape, and said free ends do not interfere with each other.

4. The electronic mobile device of claim 3, wherein said first and second handles at their same side separately have a single-finger key, and said two single-finger keys provide the function of inputting an instruction in a game mode.

5. The electronic mobile device of claim 4, wherein said first press key portion includes a cross-shape direction key disposed at said main body and an end of said display screen.

6. The electronic mobile device of claim 5, wherein said first press key portion includes a plurality of control keys disposed at said main body and another end of said display screen.

7. The electronic mobile device of claim 6, wherein said second handle comprises a power supply slot and a cover disposed inwardly from an end of said second handle, and said cover can cover an end of said power supply slot, and said power supply slot contains a power supply portion into said second handle.

8. The electronic mobile device of claim 7, wherein said second press key portion is a keyboard for dialing a call.

9. The electronic mobile device of claim 7, wherein said electronic mobile device is a mobile phone device.

10. The electronic mobile device of claim 7, wherein said electronic mobile device is a personal digital assistant.

11. The electronic mobile device of claim 7, wherein said display screen is a touch panel.

12. The electronic mobile device of claim 7, wherein said power supply portion is a battery.
